(19) United States
(12) Patent Application Publication
(10) Pub. No.: US 2006/0275091 A1
(43) Pub. Date: Dec. 7, 2006

(54) Quick stock remover

(76) Inventor: Brett Whitlock Burdick, Clinton, CT (US)

Correspondence Address: Brett W. Burdick, 16 Country Village Lane, Clinton, CT, 06413, US

(21) Appl. No.: 11/141,939

(22) Filed: Jun. 2, 2005

(51) Int. Cl. B23B 51/02

(52) U.S. Cl. 408/226

(57) ABSTRACT

To save time by being able to remove stock easily without struggling. Instead of the drill bit in a typical hole-saw to be secured, it can now be removable with a small base to free stock easily.

1. I Brett Whitlock Burdick have invented a new design for the typical hole-saw arbor where the drill shaft removes from the arbor to remove stock.

### DRAWING 1

FIG. 1. Is the front view of a hole-saw drilling material.

FIG. 2. Is the tapered cutting teeth all the way to the stock removing base.

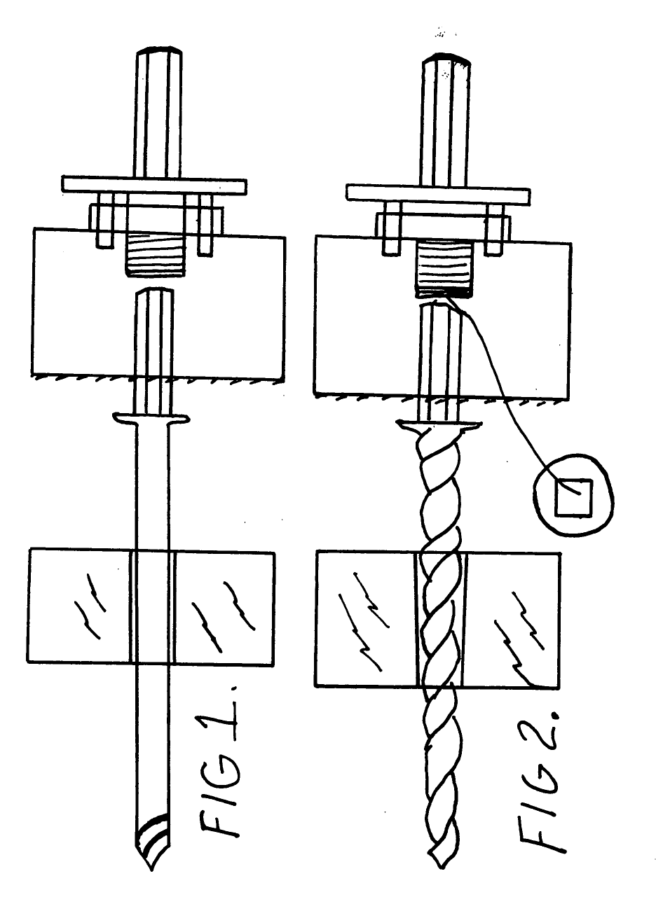

What is claimed is:

1. The drill bit has a square end at the bottom to enter arbor.

2. The arbor body has a square end to engage with drill bit.

3. The square part of the drill bit has a welded or molded stock removal base.

4. The end of the drill bit could be other shapes such as oval, spiral, or Triangle.

5. The base to remove stock could also be many other shapes like a shaft.

6. The drill tip cutting tip could taper the whole length of the shaft to free the stock easier.
